(19) United States
(12) Patent Application Publication
(10) Pub. No.: US 2005/0117037 A1
(43) Pub. Date: Jun. 2, 2005

(54) Image processing method and image processor

(76) Inventors: Keisuke Nakai, Osaka-shi, Osaka (JP); Shigeru Sasakura, Osaka-shi, Osaka (JP); Masayuki Suzuki, Osaka-shi, Osaka (JP)

Correspondence Address: Choate Hall & Stewart;Patent Group, Exchange Place, 53 State Street, Boston, MA, 02109-2804, US

(21) Appl. No.: 10/497,729

(22) PCT Filed: Dec. 2, 2002
(86) PCT No.: PCT/JP02/12576

(30) Foreign Application Priority Data
Dec. 4, 2001 (JP) 2001-370752

(51) Int. Cl. H04N 9/64

(52) U.S. Cl. 348/246

(57) ABSTRACT

An image processing method and device for quick supplement. Defective pixels (Da, Db) are detected by the difference between the imaging light in irradiation and that in nonirradiation in advance. The sound pixels surrounding the defective pixels (Da, Db) are related to the defective pixels (Da, Db) and stored in a supplement list as supplement pixels (R1 to R8, R1 to R16). An average pixel density of information on the supplement pixels (R1 to R8, R1 to R16) is determined referring to the supplement list when an image is displayed, and the average pixel density is indicated as the values of the defective pixels (Da, Db) corresponding to the supplement pixels (R1 to R8, R1 to R 16). If the difference between the imaging light in irradiation and that in nonirradiation is below a predetermined threshold, the pixels (Da, Db) are judged to be defective.

### TECHNICAL FIELD

The present invention relates to an image processing method and an image processing apparatus, which supplement an image of a defective pixel by using images of non-defective pixels surrounding the defective pixel.

### BACKGROUND ART

For example, in a digital X-ray detector etc., a linear or a point shaped defective pixels exist due to a manufacturing yield. Upon reconstruction of an image, the defective pixels lower the quality of the image so that it is necessary to supplement them by performing a certain processing.

Conventionally, in supplementing such defective pixels, the technique of detecting the defective pixels serially and supplementing them by referring to surrounding pixels at the time when the image is displayed, has mainly been used.

However, the calculation process for serially referring to the defective pixel and the pixels surrounding the defective pixel is too large to supplement the defective pixel simply and quickly. Therefore, it was substantially impossible to supplement an animation although it is possible to cope with only to a still picture.

In view of the conventional actual conditions, it is an object of the present invention to provide an image processing method and an image processing apparatus capable of carrying out supplement processing quickly.

### DISCLOSURE OF THE INVENTION

In order to accomplish the object, in an image processing method according to the present invention, an image of a defective pixel is supplemented by using images of non-defective pixels surrounding the defective pixel, and Further, the image processing method comprising steps of obtaining, beforehand, the defective pixel based on difference between an image at time of irradiation of imaging light and that at time of non-irradiation thereof, next storing non-defective pixels located around the defective pixel on a supplement list so that the non-defective pixels are related to the defective pixel as supplement pixels, and obtaining average pixel density of information on the supplement pixels by using the supplement list at the time of image display so that an image is displayed by regarding the average pixel density as a value of the defective pixel corresponding to the supplement pixels.

According to the above mentioned structure, since the defective pixel and the supplement list beforehand are made, such processing is unnecessary at the time the image supplementing processing is carried out. And since image data obtained one after another by scanning is sent to the supplement list immediately and used to supplement the defective pixel, extraordinary processing becomes quick.

In case that difference between an image at time of irradiation of imaging light and that at time of non-irradiation thereof is a predetermined threshold or less, the pixel is determined as a defective pixel.

In case that the defective pixel makes up a point, that is, in case of one defective pixel or two adjacent defective pixels, 8 or 16 pixels surrounding the defective pixel(s) are determined to be supplement pixels.

On the other hand, in case that the defective pixels form a line making up a column or a row, a pair of linear pixels adjacent to the linear defective pixels on both sides thereof is determined as supplement pixels.

The pair of pixel lines adjacent to the defective pixel line, which makes up a column or a row, on the both side of the defective pixel line, does not sometimes normally function depending on the properties of an apparatus. In this case, 3 columns or 3 rows of pixels including the pair of linear pixels may be regarded as the above mentioned defective pixels so as to carry out the above mentioned supplement.

The present invention may be used for a radiation transmission type imaging apparatus in which the imaging light is radiation for transmission imaging which is emitted from a radiation source.

The radiation transmission type imaging apparatus in which the imaging light is radiation for transmission imaging which is emitted from the radiation source may further have a radiation detector for imaging.

According to another aspect of the image processing apparatus of the present invention, the image processing apparatus has the supplement list and a supplement program in which average pixel density of the information on the supplement pixels is obtained by using the supplement list at time of image display, and an image is displayed by regarding the average pixel density as a value of the defective pixel corresponding to the supplement pixels. The supplement program and the supplement list exist as a file, and also may be stored by performing writing etc. to an IC chip.

Thus, according to the features of the image processing method and the image processing apparatus of the present invention, it is possible to carry out the supplement processing quickly. In addition, in such a way, the supplement processing of not only a still picture but also an animation became possible.

Other objects, structures, and effects of the present invention become apparent from the following description.

### BRIEF DESCRIPTION OF THE DRAWINGS

FIG. 1 is a block diagram showing an image processing apparatus according to the present invention.

FIGS. 2 (a), (b) and (c) show an image on a screen of a radiation detector in case that X-ray is not irradiated (image A), in case that X-ray is irradiated (Image B), and in case that the Image A is subtracted from the Image B, respectively.

FIGS. 3 (a) and (b) show how to supplement a point shape defective portion in case that the point shape defective portion comprises one pixel, and in case that the point shape defective portion comprises two adjoining pixels, respectively.

FIG. 4 is a diagram showing how to supplement point-like defective pixels.

FIG. 5 is a flow chart showing a procedure in which a defective pixel map is created.

FIG. 6 is a flow chart showing a procedure in which a supplement list is created.

FIG. 7 is a flow chart showing a defective pixel supplement processing procedure.

### THE BEST MODE FOR REDUCING THE INVENTION TO PRACTICE

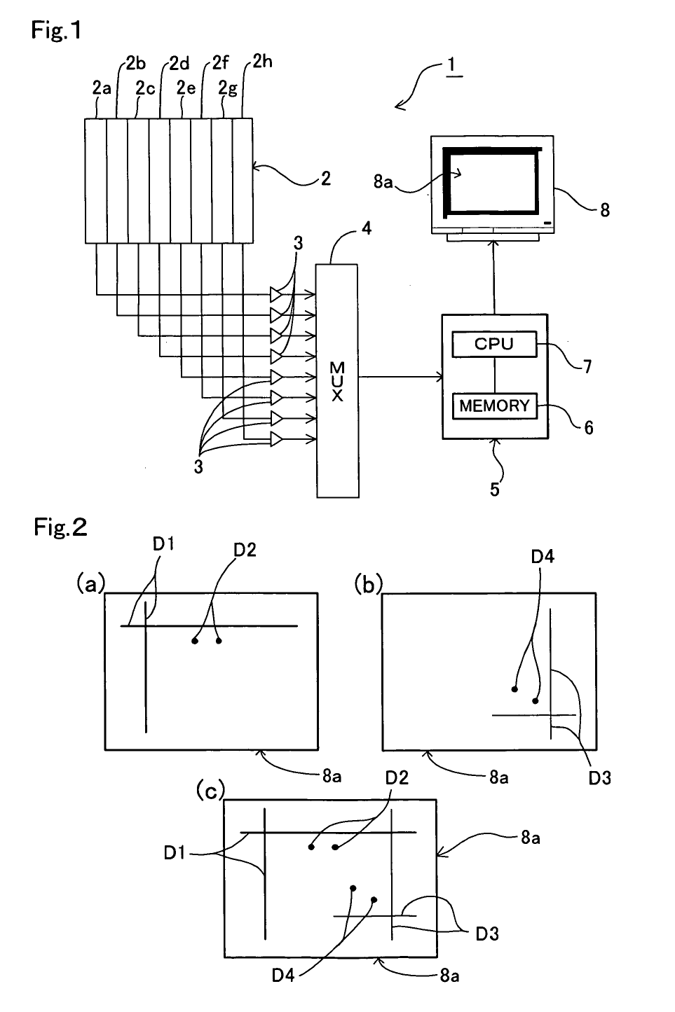

Next, a first embodiment of the present invention will be described, referring to FIGS. 1 to 3. In an image processing apparatus shown in FIG. 1, a sample is transmitted by X-ray emitted from a radiation source which is not shown, and an image of the transmitting X ray is taken by a digital X-ray detector 2. The detector 2 has a pixel matrix structure like a liquid crystal display, and a scintillator, which changes X-ray energy into light, is attached on an X-ray acceptance surface.

X-ray received in eight sections 2a to 2h is sent to an amplifier 3 at once, and is inputted one by one into a personal computer 5 by switching by a multiplexer 4. In the amplifier 3 or the multiplexer 4, adjustment is made so that an offset amount which is different depending on sections 2a to 2h or amplifier 3 is equalized.

The personal computer 5 has a memory 6 and a CPU 7. And while algorithm, which is described below, is expanded in a memory space, data processing is performed. A processed result is displayed on a display screen 8a of a monitor 8.

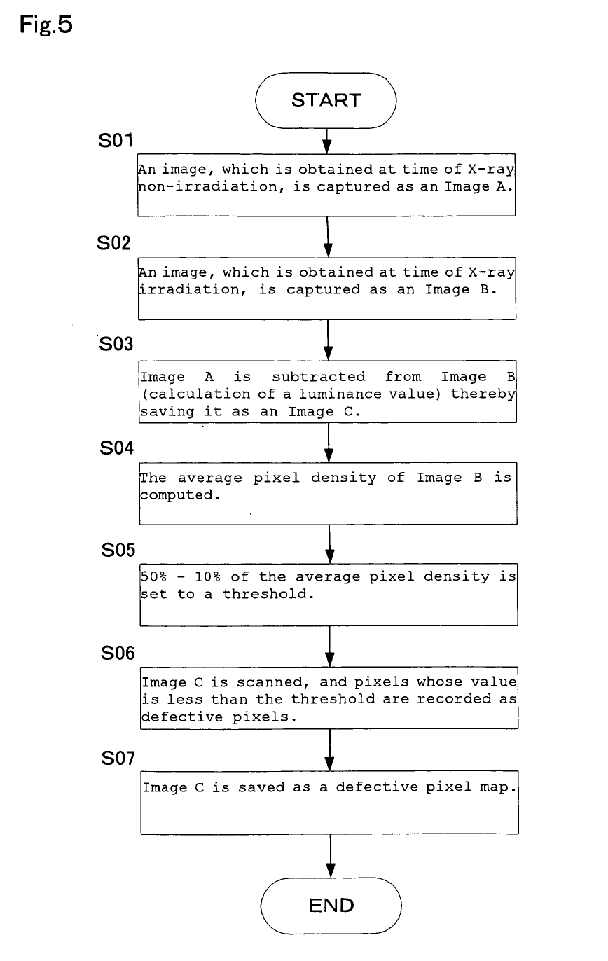

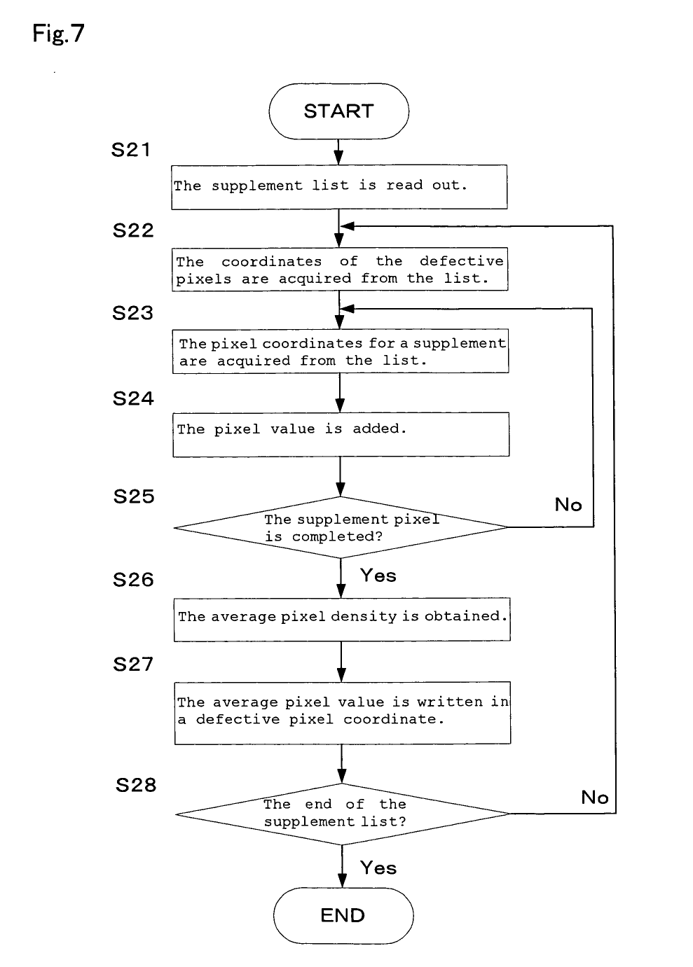

Next, the procedure of the image processing method in the image processing apparatus is described, referring to FIGS. 5 to 7.

First, as shown in FIG. 5, an image as shown in FIG. 2 (a), which is obtained at the time of X-ray non-irradiation is captured as an Image A (S01). In this case, a linear defect portion D1 and a point-like defect portion D2 will be displayed with brightness. Next, an image as shown in FIG. 2(b), which is obtained at the time of the X-ray irradiation is captured as an Image B (S02). At this time, the linear defect portion D1 and the point-like defect portion D2 are displayed as a dark image respectively. In addition, in order to compute a luminance value, the Image A is subtracted from the Image B so as to save the subtracted image as an Image C (S03). In the Image C, the defective portions D1 to 4 are displayed as dark lines or points.

On the other hand, the average pixel density of the Image B is computed (S04). First, a fixed value, for example, 50%-10% of the average pixel density, is set to a threshold (S05), and the Image C is scanned, and pixels whose value is less than the threshold are recorded as defective pixels (S06). And the Image C is saved as a defective pixel map including the position information of the defect portions D1 to 4 (S07).

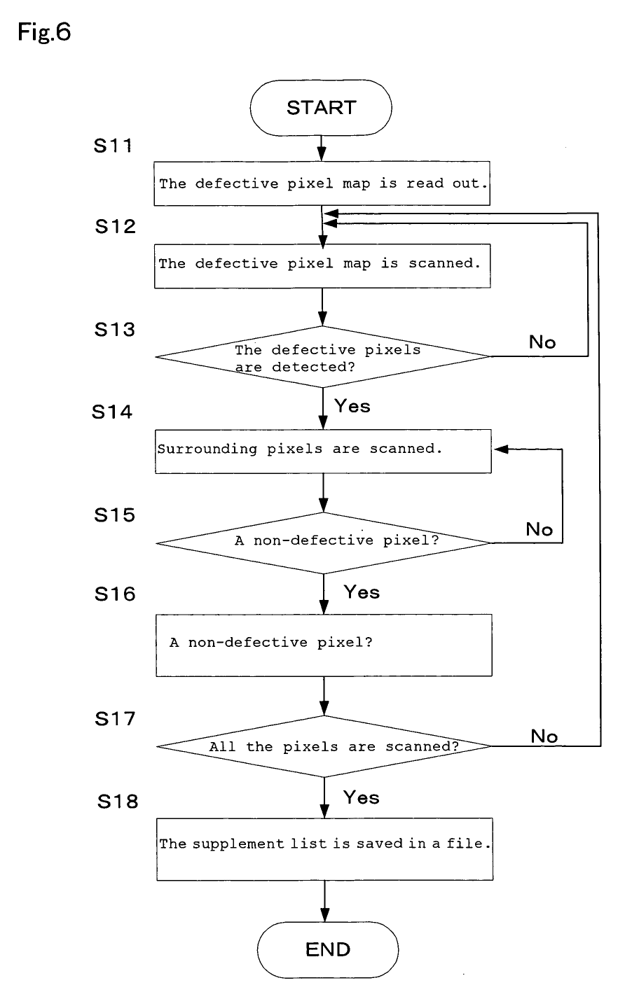

In creation of the supplement list, as shown in FIG. 6, first, the defective pixel map is read out (S11), the defective pixel map is scanned (S12), the defective pixels (S13) are detected, and then surrounding pixels are scanned (S14).

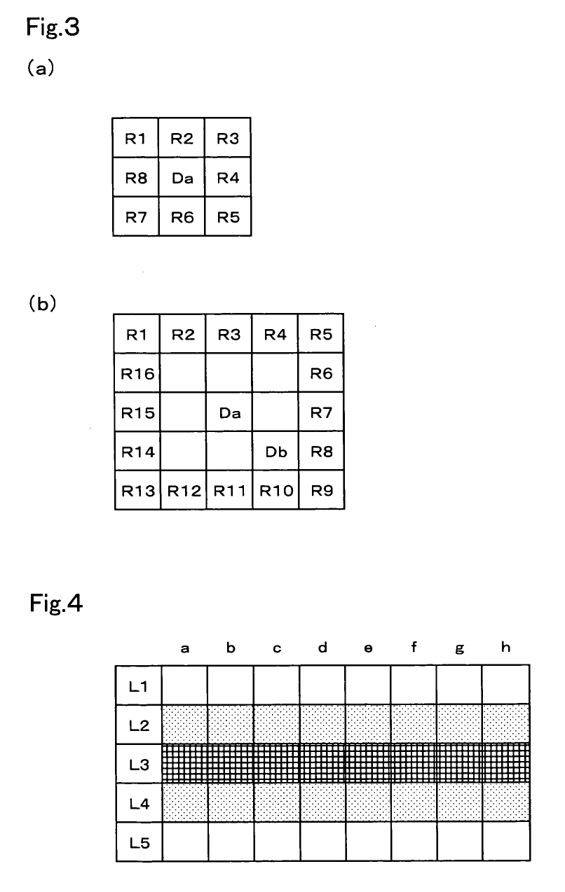

Here, description of compensation pattern of the defective pixel based on the surrounding pixels will be given. First, when a point as shown FIG. 3 (a) is a defective pixel Da, by using eight pixels R1 to 8 surrounding the defective pixel Da, the defective pixel Da is supplemented by using the average value of these surrounding pixels R1 to 8. In case that two defective pixels Da and Db are adjacent to each other as shown in FIG. 3 (b), the defective pixels Da and Db are supplemented by using the average value of 16 pixels R1 to 16 which surround rectangularly the defective pixel Da which is scanned first.

On the other hand, as shown in FIG. 4, when a line of defective pixels L3 has occurred, a pair of pixel rows L2 and L4 which are adjacent to the defective pixels L3, respectively is used for supplement, wherein each part of the pixel row L2 and L4 is related to respective parts of the pixel row L3 in a vertical direction so that each of the defective pixels L3 is supplemented by the average value of the corresponding related pixels. For example, a coordinate, column L3 and row c is supplemented by the average value of pixels whose coordinates are column L2, row c and column L4 and row c, respectively.

However, the pair of pixel rows L2 and L4, which is adjacent to the defective pixel line L3, may be imperfect due to the properties of the detector. In this case, first, the pixel rows L2 and L4 are supplemented by pixel rows L1 and L5, and the pixel row L3 is supplemented by the pixel rows L2 and L4. The pixel rows L2, L3, and L4 may be viewed as being uniformly supplemented by the pixel rows L1 and L5.

In procedure, it is judged whether or not a pixel of each coordinate is a non-defective (S15), and when it is not a non-defective pixel, surrounding pixels are examined further (S15). When two defective pixels adjacent to each other are detected, the defective pixels are processed as shown in FIG. 3 (ab), and in the case of a non-defective pixel, as described above, a defective pixel is registered in the supplement list with a correspondence relation with surrounding supplement pixels (S16). If the same scanning is performed on all pixels (S17) and the scanning of all the pixels is completed, the supplement list is saved in a file (S18).

Since the supplement list file created in such a way is peculiar to each detector 2, they are combined and provided. That is, since the supplement list file is created beforehand, the supplement processing is accelerated. The program, which performs the above mentioned procedure, is not included in an actual image processing apparatus, and only a program file required for the supplement processing and the supplement list file are saved therein. In the supplement list file, at least the defective pixels (R1 to 8, R1 to 16, L1, L2, L4, L5) and coordinates of the defective pixels (Da, Db, L3) corresponding to these supplement pixels are described.

In the supplement processing using the program file for performing the supplement processing, the above mentioned supplement list is read out (S21), and the coordinates of the defective pixels are first acquired from the list (S22). Furthermore, if the pixel coordinates for a supplement are acquired from the list (S23), the pixel value is added (S24) and the supplement pixel is completed (S25), the average pixel density is obtained (S26), and the average pixel value is written in a defective pixel coordinate (S27). The above mentioned operation is repeatedly performed until the end of the supplement list (S28).

In addition, the supplement list and the supplement program are saved as a file, and they may also be written and save in an IC chip. Numerals are inserted in the claims merely for making reference to the drawings convenient, and the present invention is not limited to the structure described in the accompanying drawings even by the insertion.

### INDUSTRIAL APPLICABILITY

Although the present invention is used for image processing of an image taken by a digital X ray detector or a black and white camera and the like, the present invention can be applied in case of radiation other than X-ray, that is, visible light, ultraviolet rays, and infrared radiation. In addition, it is not limited to such a black and white camera, and in case of a color camera, the same processing can be performed for every color channel.

1. An image processing method for supplementing an image of a defective pixel using images of non-defective pixels surrounding the defective pixel, the image processing method comprising steps of:
obtaining, beforehand, the defective pixel (Da, Db, L3) based on difference between an image at time of irradiation of imaging light and that at time of non-irradiation thereof,
storing next, non-defective pixels located around the defective pixel (Da, Db, L3) on a supplement list so that the non-defective pixels are related to the defective pixel (Da, Db, L3) as supplement pixels (R1-8, R1-16, L1, L2, L, L5), and
obtaining average pixel density of information on the supplement pixels (R1-8, R1-16, L1, L2, L4, L5), by using the supplement list at the time of image display so that an image is displayed by regarding the average pixel density as a value of the defective pixel (Da, Db, L3) corresponding to the supplement pixels (R1-8, R1-16, L1, L2, L4, L5).

2. The image processing method according to claim 1, wherein in case that the difference between an image at time of irradiation of imaging light and that at time of non-irradiation thereof is a predetermined threshold or less, a pixel is determined as a defective pixel (Da, Db, L3).

3. The image processing method according to claim 2, wherein in case of one defective pixel or two defective pixels adjacent to each other (Da, Db), 8 or 16 pixels surrounding the one defective pixel or two defective pixels (Da, Db) are determined as the supplement pixels.

4. The image processing method according to claim 3, wherein in case that the defective pixels (L3) form a line making up a column or a row, a pair of linear pixels adjacent to the linear defective pixels (L3) on both sides are determined as the supplement pixels (L2, L4).

5. The image processing method according to claim 4, wherein 3 rows or 3 columns (L2, L3, L4) including the pair of linear pixels adjacent to the linear defective pixels forming a row or a column on the both sides are regarded as the defective pixels so that the supplement is performed.

6. The image processing method according to claim 5, wherein the imaging light is radiation for transmission imaging, which is emitted from a radiation source.

7. An image processing apparatus in which the image processing method according to claim 5 is performed, wherein the imaging light is radiation for transmission imaging which is emitted from a radiation source, and further including a radiation detector for imaging.

8. An image processing apparatus in which the image processing method according to claim 6 is performed, comprising: the supplement list and a supplement program in which average pixel density of the information on the supplement pixels is obtained by using the supplement list at time of image display, and an image is displayed by regarding the average pixel density as a value of the defective pixel corresponding to the supplement pixels.

9. The image processing method according to claim 1, wherein in case of one defective pixel or two defective pixels adjacent to each other (Da, Db), 8 or 16 pixels surrounding the one defective pixel or two defective pixels (Da, Db) are determined as the supplement pixels.

10. The image processing method according to claim 1, wherein in case that the defective pixels (L3) form a line making up a column or a row, a pair of linear pixels adjacent to the linear defective pixels (L3) on both sides are determined as the supplement pixels (L2, L4).

11. The image processing method according to claim 1, wherein 3 rows or 3 columns (L2, L3, L4) including the pair of linear pixels adjacent to the linear defective pixels forming a row or a column on the both sides are regarded as the defective pixels so that the supplement is performed.

12. The image processing method according to claim 1, wherein the imaging light is radiation for transmission imaging, which is emitted from a radiation source.

13. An image processing apparatus in which the image processing method according to claim 1 is performed, wherein the imaging light is radiation for transmission imaging which is emitted from a radiation source, and further including a radiation detector for imaging.

14. An image processing apparatus in which the image processing method according claim 1 is performed, comprising: the supplement list and a supplement program in which average pixel density of the information on the supplement pixels is obtained by using the supplement list at time of image display, and an image is displayed by regarding the average pixel density as a value of the defective pixel corresponding to the supplement pixels.
